(19) United States
(12) Patent Application Publication
(10) Pub. No.: US 2014/0195585 A1
(43) Pub. Date: Jul. 10, 2014

(54) PROCESS EXECUTING SYSTEM, PROCESS EXECUTING METHOD, AND INFORMATION PROCESSING DEVICE

(71) Applicant: Ayumi MIHARA, Tokyo (JP)

(72) Inventor: Ayumi MIHARA, Tokyo (JP)

(73) Assignee: RICOH COMPANY, LTD., Tokyo (JP)

(21) Appl. No.: 14/104,010

(22) Filed: Dec. 12, 2013

(30) Foreign Application Priority Data
Jan. 8, 2013 (JP) 2013-001157

(51) Int. Cl. H04L 29/08

(52) U.S. Cl. CPC H04L 67/10
USPC 709/201

(57) ABSTRACT

A process executing system includes a first device and a second device connected via a network. The second device includes a receiving unit configured to receive process definition information and process object data from the first device, a control unit configured to analyze the process definition information and determine whether the next process is to be executed at the self-device, a process execution unit configured to execute the next process on the process object data when the next process is determined to be executed at the self-device, an updating unit configured to update the process definition information by changing a definition of a process, which is defined to be processed after the next process according to the execution order, to be a new next process, and a sending unit configured to send the process definition information and the process object data to another second device other than the self-device.

### BACKGROUND OF THE INVENTION

1. Field of the Invention

The present invention relates to a process executing system in which one or more devices for executing a process are connected via a network.

2. Description of the Related Art

There is known a network system in which each of the devices connected to a network processes data according to procedures that have been set. Each device includes modules for processing the data by unique functions (for example, modules referred to as a plug-in and an application), and can perform various processes according to the combination of modules (see, for example, Patent Document 1). Patent Document 1 discloses a communication device for communicating with a plurality of external devices, receiving data from a certain external device, sending the received data to another external device, and causing the other external device to process the data, thereby realizing data processing performed by combining functions of a plurality of external devices.

Data processing performed by combining modules is referred to as a workflow, and the processing procedures of the workflow are referred to as flow definition information. For example, when “scan original document→OCR→send electronic mail” is set in the flow definition information, the workflow is executed by the modules of one or more devices.

However, in a conventional network system, the control device that performs workflow control plays a central role in delivering the job data used in the workflow (for example, image data obtained by scanning) to each of the devices, and therefore the load is concentrated at the control device and the network.

FIG. 18 illustrates an example of transferring job data in a network system. The respective devices in the network system are connected via a network 400.

A. The job data scanned by a scanner of an MFP (multifunction peripheral) 201 is sent to the control device.
B1. The control device sends the job data to a server 1 for performing an OCR process.
B2. The server 1 sends the job data that has undergone the OCR process to the control device.
C1. The control device sends the job data to the server 2 for sending the job data by e-mail.
C2. The server 2 sends the sending result to the control device.

As described above, when a plurality of devices execute the workflow, the sending/receiving of the job data is concentrated at the control device.

Patent Document 1: Japanese Laid-Open Patent Publication No. 2012-063972

### SUMMARY OF THE INVENTION

The present invention provides a process executing system, a process executing method, and an information processing device, in which one or more of the above-described disadvantages are eliminated.

According to an aspect of the present invention, there is provided a process executing system including a first device configured to receive a plurality of processes and a setting of an execution order of the plurality of processes; and at least one second device configured to execute the plurality of processes, wherein the first device and the at least one second device are connected via a network, wherein the first device includes a first sending unit configured to send, to the at least one second device, process definition information defining process contents of each of the plurality of processes and a next process to be executed subsequently in the plurality of processes, and process object data or instruction information of the process object data, and the at least one second device includes a receiving unit configured to receive the process definition information and the process object data or the instruction information of the process object data, a process execution control unit configured to analyze the process definition information and determine whether the next process is to be executed at a self-device (the device itself), which is the at least one second device in which the process execution control unit is included, a process execution unit configured to execute the next process on the process object data when the process execution control unit determines that the next process is to be executed at the self-device, a definition information updating unit configured to update the process definition information by changing a definition of one of the plurality of processes, which is defined to be processed after the next process according to the execution order, to be a new next process, and a second sending unit configured to send the process definition information and the process object data to an other one of the at least one second device other than the self-device.

According to an aspect of the present invention, there is provided a process executing method performed by a process executing system including a first device configured to receive a plurality of processes and a setting of an execution order of the plurality of processes, and at least one second device configured to execute the plurality of processes, wherein the first device and the at least one second device are connected via a network, the process executing method including sending, from the first device to the at least one second device, process definition information defining process contents of each of the plurality of processes and a next process to be executed subsequently in the plurality of processes, and process object data or instruction information of the process object data; receiving, by the at least one second device, the process definition information and the process object data or the instruction information of the process object data; analyzing, by the at least one second device, the process definition information and determining, by the at least one second device, whether the next process is to be executed at a self-device, which is the at least one second device performing the determining; executing, by the at least one second device, the next process on the process object data when the next process is determined to be executed at the self-device; updating, by the at least one second device, the process definition information by changing a definition of one of the plurality of processes, which is defined to be processed after the next process according to the execution order, to be a new next process; and sending, by the at least one second device, the process definition information and the process object data to an other one of the at least one second device other than the self-device.

According to an aspect of the present invention, there is provided an information processing device including a communicating unit configured to communicate, via a network, with a first device that receives a plurality of processes and a setting of an execution order of the plurality of processes; a receiving unit configured to receive process definition information defining process contents of each of the plurality of processes and a next process to be executed subsequently in the plurality of processes, and process object data or instruction information of the process object data; a process execution control unit configured to analyze the process definition information and determine whether the next process is to be executed at a self-device, which is the information processing device in which the process execution control unit is included; a process execution unit configured to execute the next process on the process object data when the process execution control unit determines that the next process is to be executed at the self-device; a definition information updating unit configured to update the process definition information by changing a definition of one of the plurality of processes, which is defined to be processed after the next process according to the execution order, to be a new next process; and a sending unit configured to send the process definition information and the process object data to an other information processing device other than the self-device.

### BRIEF DESCRIPTION OF THE DRAWINGS

Other objects, features and advantages of the present invention will become more apparent from the following detailed description when read in conjunction with the accompanying drawings, in which:

FIG. 1 schematically illustrates a process executing system according to a first embodiment;

FIG. 2 illustrates a system configuration of the process executing system;

FIG. 3 illustrates a hardware configuration of a workflow execution request device as an MFP;

FIG. 4 illustrates a hardware configuration of a delivery server;

FIGS. 5A through 5C are diagrams for describing examples of flow definition information;

FIG. 6 is an example of a functional block diagram of the workflow execution request device, the delivery server, and the service providing device;

FIG. 7 illustrates an example of a device determination table;

FIG. 8 illustrates an example of overall operation procedures by the process executing system;

FIG. 9 is an example of a flowchart indicating the procedures when the delivery server or the service providing device executes a process;

FIG. 10 illustrates a system configuration of a process executing system according to a second embodiment;

FIGS. 11A through 11C schematically illustrate an example of the creating of flow definition information;

FIG. 12 illustrates an example of overall operation procedures by the process executing system according to the second embodiment;

FIG. 13 is an example of a flowchart indicating the procedures when the delivery server or the service providing device executes a process according to the second embodiment;

FIG. 14 is an example of a functional block diagram of the workflow execution request device, the delivery server, and the service providing device according to a third embodiment;

FIGS. 15A through 15D schematically illustrate examples of association information of various patterns;

FIGS. 16A and 16B illustrate examples of user information in the flow definition information before and after being updated;

FIG. 17 is a flowchart of procedures performed when the delivery server or the service providing device executes a process according to the third embodiment; and

FIG. 18 illustrates an example of transferring job data in a network system.

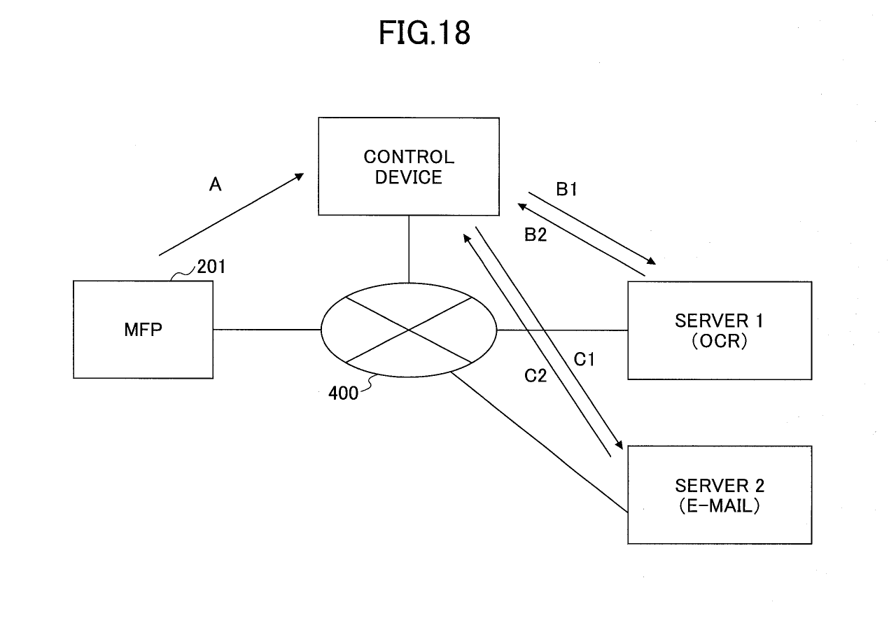

### DETAILED DESCRIPTION OF THE PREFERRED EMBODIMENTS

A description is given, with reference to the accompanying drawings, of embodiments of the present invention. However, the technical scope of the present invention is not limited to the following embodiments.

### First Embodiment

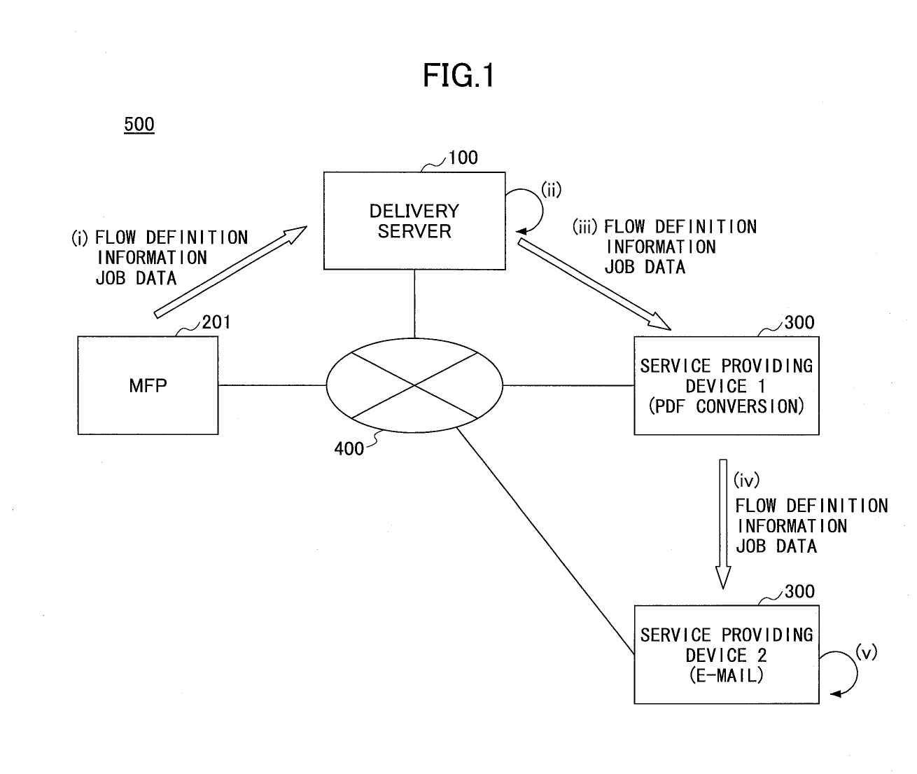

FIG. 1 schematically illustrates a process executing system 500 according to a first embodiment. An MFP (multifunction peripheral) 201, a delivery server 100, and service providing devices 300 (hereinafter, referred to as service providing devices 1 and 2 when distinguished), are connected via a network 400 so that communication is possible.

(i) The user defines a workflow including one or more processes, by operating the MFP 201. For example, it is assumed that the user has set a workflow including “PDF conversion→send e-mail”. This sequence of processes becomes the flow definition information. In the flow definition information, a process to be executed next is specified as a current point (corresponding to “next process”). Before the workflow starts, PDF conversion is the current point. The MFP 201 sends the flow definition information and the job data (image data, etc.) to the delivery server 100.

(ii) The delivery server 100 analyzes the flow definition information, and updates the flow definition information by associating each of the process in the flow definition information with a service providing device. The service providing devices 1 and 2 are determined as devices for performing the PDF conversion and sending the e-mail, respectively. Note that there are cases where the delivery server 100 executes a process.

(iii) The delivery server 100 sends the flow definition information and the job data to the service providing device 1 that is to perform the process set as the current process.

(iv) The service providing device 1 analyzes the flow definition information and determines whether the self-device (the service providing device 1 itself) is an execution object device. When the self-device is an execution object device, the service providing device 1 executes the process specified as the current point. Then, the service providing device 1 updates the current point to the next process in the flow definition information, and sends the flow definition information and the job data to the service providing device 2 that is to perform the next process.

(v) The service providing device 2 analyzes the flow definition information and determines whether the self-device is an execution object device. When the self-device is an execution object device, the service providing device 2 executes the process specified as the current point. Then, the service providing device 2 updates the current point to the next process in the flow definition information, and sends the flow definition information and the job data to a service providing device that is to perform the next process. In this example, there is no next process, and therefore the workflow ends here.

Accordingly, after the delivery server 100 first sends the flow definition information and the job data, the amount of communication with each of the service providing devices can be reduced (the delivery server 100 mainly receives execution results), and therefore it is possible to reduce the processing load concentrated at the delivery server 100 and to reduce the communication load concentrated at the network to which the delivery server 100 is connected.

### Configuration Example

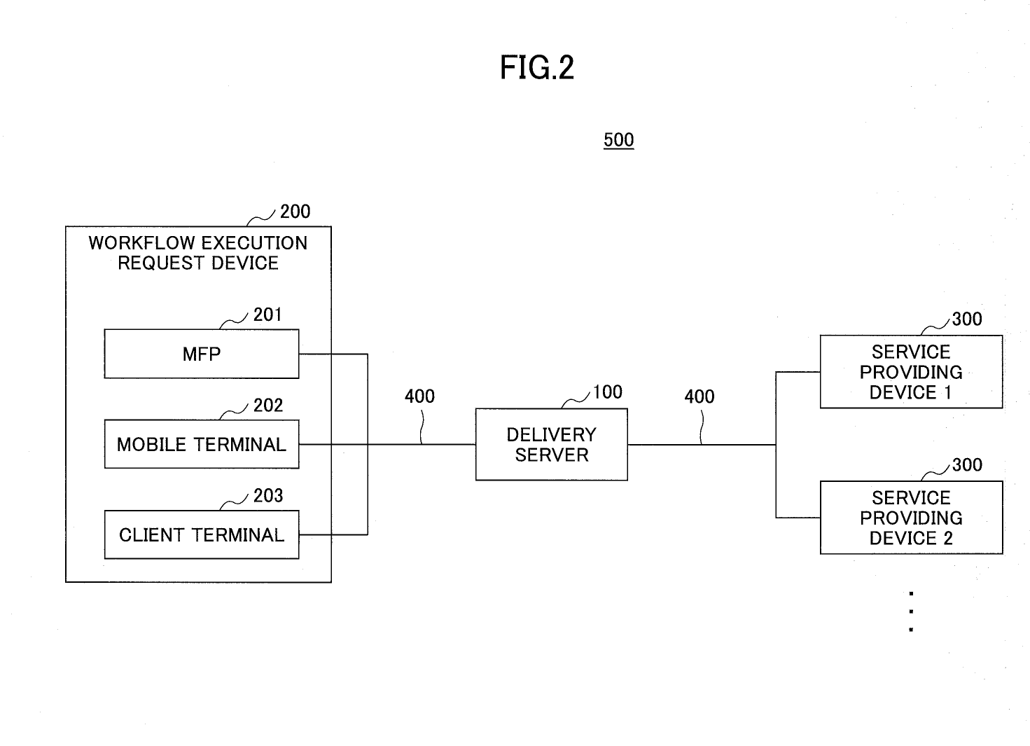

FIG. 2 illustrates a system configuration of the process executing system 500. A workflow execution request device 200 is connected with one or more service providing devices 300 via the network 400, centering around the delivery server 100. The delivery server 100 is illustrated at the center merely to indicate the position in the process; the workflow execution request device 200 and the service providing devices 300 are also connected with each other via the network 400.

The network 400 is a LAN, or a WAN in which a plurality of LANs are connected via a router, etc. Furthermore, the Internet may be included, if a firewall does not need to be considered. The network 400 may be constructed by wires, or a part of or the entirety of the network 400 may be constructed by a wireless LAN (IEEE802.11b/a/g/n, etc.). Furthermore, the network 400 includes a communication network constructed for mobile bodies, such as a mobile phone network, a WiMAX network, and a PHS network. Note that even when the devices in the process executing system 500 communicate with each other in a one-on-one manner by an ad hoc mode of a wireless LAN, etc., the devices are included in the network 400.

The workflow execution request device 200 is a device for requesting the delivery server 100 to execute a workflow. For example, a MFP 201, a mobile terminal 202, and a client terminal 203 are illustrated; however, an information processing device having a communication function may be the workflow execution request device 200. There are one or more workflow execution request devices 200 present in the process executing system 500. The MFP 201 is a device including functions for forming images, such as functions of a copier, a scanner, a printer, and a fax machine. The MFP 201 is to include one or more of these functions. The MFP 201 sends image data created by scanning an original document to the delivery server 100 as job data, and also sends flow definition information, to request the delivery server 100 to execute the workflow.

The mobile terminal 202 is a terminal that is carried or held by a user, such as a mobile phone, a smartphone, a tablet terminal, a PDA (Personal Digital Assistant), and a digital camera. For example, the user sends, as job data, image data taken with a camera of a mobile phone or a digital camera to the delivery server 100, and also sends the flow definition information, to request to the delivery server 100 to execute a workflow.

The client terminal 203 is an information processing device used by the user, such as a notebook PC (Personal Computer), a desktop PC, a work station, and a TV conference terminal. For example, the client terminal 203 sends, to the delivery server 100, application data created by the application and Web data acquired from the Web as job data, and also sends flow definition information, to request the delivery server 100 to execute a workflow.

Note that the workflow execution request device 200 is a device that is directly operated by the user; however, the job data does not need to be created or stored by a device that is directly operated by the user. For example, the client terminal may specify job data stored in NAS (Network Attached Storage) or another device, and have the NAS, etc., send the job data to the delivery server 100 (have the delivery server 100 read the job data from NAS).

The delivery server 100 is an information processing device such as a PC, a server device, and a thin client. The MFP may be the delivery server. For example, when image data and flow definition information are received as job data from the MFP 201, the delivery server 100 executes a delivery process according to the flow definition information. Note that there may be one delivery server 100, or more than one delivery servers 100. The delivery server 100 may also have a function of the service providing device 300.

The service providing device 300 is an information processing device such as a PC, a server device, and a thin client. An MFP may be the service providing device 300. The service providing device 300 analyzes the flow definition information and executes a process. For example, when image data and flow definition information are received from the delivery server 100 as job data, the service providing devices 300 performs an OCR process on the image data and sends the data by e-mail, according to the flow definition information. Note that there are one or more service providing devices 300. Furthermore, there may be cases where a single service providing devices 300 performs a plurality of processes.

Both the delivery server 100 and the service providing device 300 execute a process defined by the flow definition information, and therefore these devices may be simply referred to as a “device” when they do not need to be distinguished from each other.

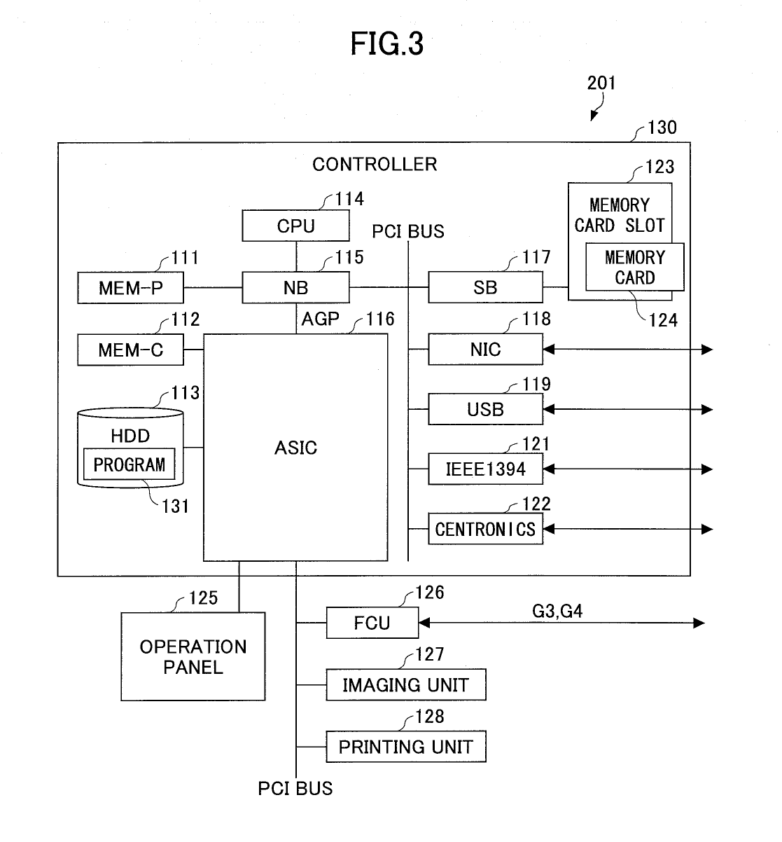

FIG. 3 illustrates a hardware configuration of the workflow execution request device 200 as the MFP 201. The MFP 201 includes a controller 130, an operation panel 125, a fax control unit (FCU) 126, an imaging unit 127, and a printing unit 128.

The controller 130 includes a CPU 114, an ASIC 116, a NB (north bridge) 115, a SB (south bridge) 117, a MEM-P (system memory) 111, a MEM-C (local memory) 112, a HDD (hard disk drive) 113, a memory card slot 123, a NIC (network interface controller) 118, a USB device 119, an IEEE 1394 device 121, and a centronics device 122.

The CPU 114 is an IC for executing various information processes, and executes applications in units of processes in parallel on an OS or a platform. The ASIC 116 is an IC for image processing. The NB 115 is a bridge for connecting the CPU 114 and the ASIC 116. The SB 117 is a bridge for connecting the NB 115 with peripheral devices. For example, the ASIC 116 and the NB 115 may be connected via an AGP (Accelerated Graphics Port).

The MEM-P 111 is a memory connected to the NB 115. The MEM-C 112 is a memory connected to the ASIC 116. The HDD 113 is a storage connected to the ASIC 116, and is used for accumulating image data, document data, programs, font data, and form data. The HDD 113 stores various applications (copy application, scanner application, printer application, fax application, etc.) and programs 131. The programs 131 are for receiving a setting of the workflow set by the user, and creating flow definition information, etc.

The memory card slot 123 is connected to the SB 117, and is used for setting (inserting) a memory card 124. The memory card 124 is a flash memory such as a USB memory and an SD memory, and is used for distributing the programs 131. Furthermore, the programs 131 may be distributed by downloading the programs 131 to the MFP 201 from a predetermined server.

The NIC 118 is a controller for performing data communication using a MAC address, etc., via the network 400, etc. The USB device 119 is a device for providing a serial port complying with the USB specification. The IEEE 1394 device 121 is a device for providing a serial port complying with the IEEE 1394 specification. The centronics device 122 is a device for providing a parallel port complying with the centronics specification. The NIC 118, the USB device 119, the IEEE 1394 device 121, and the centronics device 122 are connected to the NB 115 and the SB 117 via a PCI (Peripheral Component Interconnect) bus.

The operation panel 125 is a hardware component (operation unit) used by the user for inputting information to the MFP 201, and is also a hardware component (display unit) by which the MFP 201 displays a menu screen. The operation panel 125 is connected to the ASIC 116. The FCU 126, the imaging unit 127, and the printing unit 128 are connected to the ASIC 116 via a PCI (Peripheral Component Interconnect) bus.

The imaging unit 127 optically scans an original document placed on the contact glass, performs image processing of A/D converting the reflected light, and generating color or monochrome digital data (hereinafter, also referred to as “image data”).

The printing unit 128 includes, for example, a tandem type photoconductive drum, and forms a latent image by modulating a laser beam and scanning the photoconductive drum, based on the above image data and PDL data received from a user PC. An image, which is developed on each page by causing toner to adhere to the latent image, is transferred onto a sheet by heat and pressure. The printing unit 128 is not limited to such a plotter of an electrophotographic method; the printing unit 128 may be an inkjet type plotter engine for forming images by jetting liquid droplets.

The FCU 126 sends and receives image data in accordance with, for example, a communication procedure complying with the specifications of T.37 and T.38 by connecting to the network 400 via the NIC 118, or a communication procedure complying with the specifications of G3 and G4 by connecting to a public communication network. Furthermore, even when image data is received when the power of the MFP 201 is off, the image data can be printed onto a sheet by activating the printing unit 128.

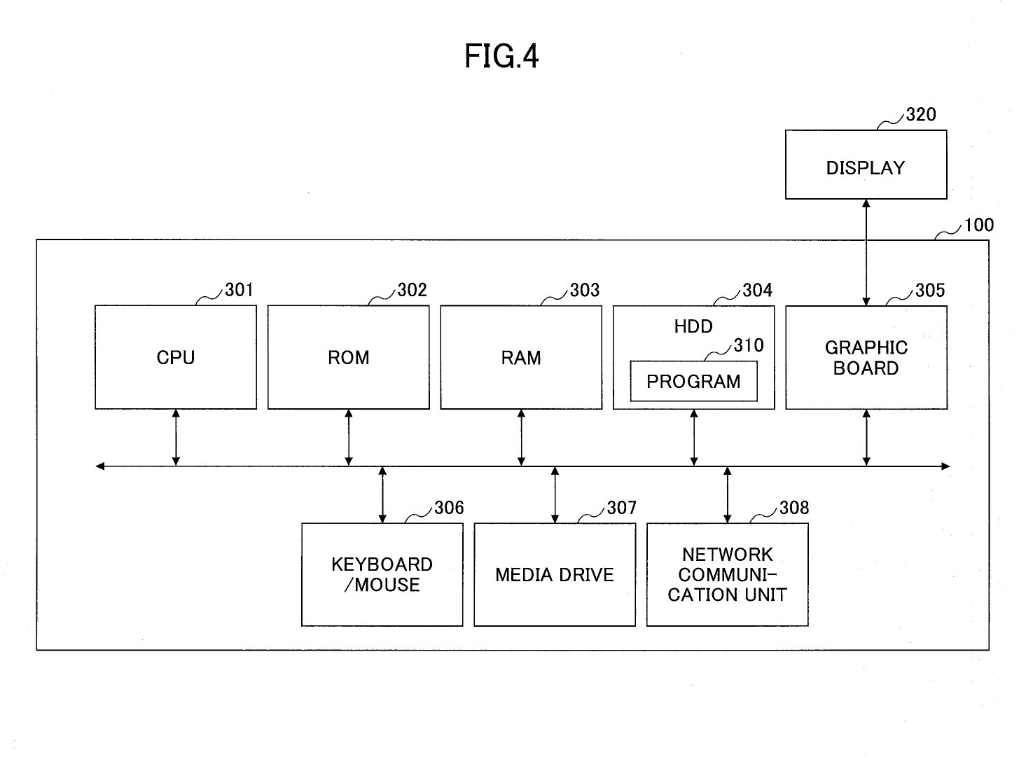

FIG. 4 illustrates a hardware configuration of the delivery server 100. The delivery server 100 includes a CPU 301, a ROM 302, a RAM 303, a HDD 304, a graphic board 305 to which a display 320 is connected, a keyboard/mouse 306, a media drive 307, and a network communication unit 308, which are connected to a bus. The CPU 301 loads a program 310, which is stored in the HDD 304, in the RAM 303, and executes the program 310, controls the respective components, inputs and outputs data, and processes data. The ROM 302 stores a BIOS and a start program for loading a boot strap loader from the HDD 304 into the RAM 303. The boot strap loader loads the OS from the HDD 304 into the RAM 303.

The HDD 304 may be a non-volatile memory, and may be a SSD (Solid State Drive). The HDD 304 stores an OS, a device driver, and a program 310 for providing functions described below. The display 320 displays a GUI screen created by the graphic board 305 according to instructions from a program.

The keyboard/mouse 306 is an input device for receiving operations from a user. The media drive 307 is for writing/reading data in an optical medium such as a compact disk, a DVD, and a Blu-ray disc. Furthermore, the media drive 307 is for writing/reading data in a memory card such as a flash memory. The network communication unit 308 is an Ethernet (registered trademark) card for connecting to, for example, LAN. The processing of protocols of TCP/IP (UDP/IP) and an application layer is performed by the OS and the program 310. There are various protocols of the application layer, such as SNMP (Simple Network Management Protocol), HTTP, FTP, and SMB (Server Message Block).

The program 310 is a file having an installable format or an executable format, which is distributed by being recorded in computer-readable recording media. Furthermore, the program 310 is distributed as a file having an installable format or an executable format, from a server (not shown).

Flow Definition Information

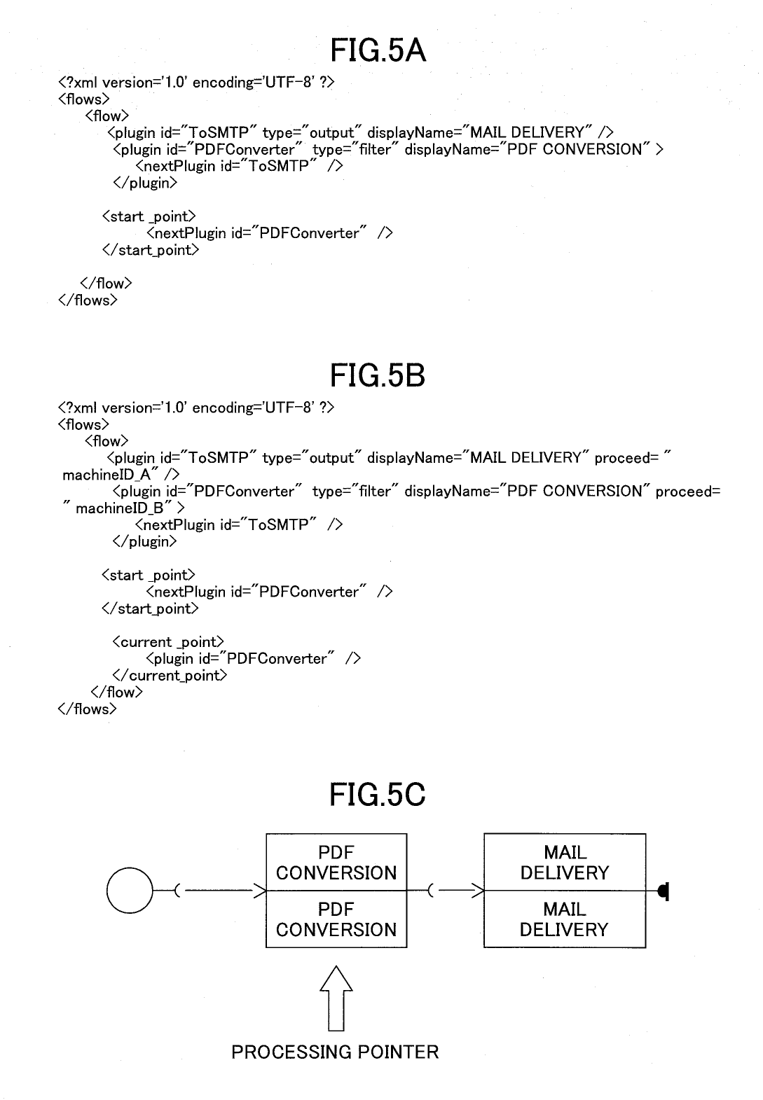

FIGS. 5A through 5C are diagrams for describing examples of flow definition information. FIG. 5A illustrates flow definition information sent from the workflow execution request device 200 to the delivery server 100, and FIG. 5B illustrates flow definition information sent from the delivery server 100 to the service providing device 300.

The user accesses the delivery server 100 by the workflow execution request device 200, and receives screen data from the delivery server 100. In the screen data, a menu for defining a workflow is displayed, and the user defines a workflow by setting the process order and the process contents for a plurality of processes desired by the user (conditions necessary for the processes, such as the destination (e-mail address) for sending an e-mail, the destination for sending a fax, a destination for storing a document box, and print conditions). The items that need to be set in each process are determined, and therefore in the screen, a menu for setting the necessary processing contents is displayed according to the process selected by the user.

Process 1. PDF conversion
Document data: ABC.doc
Process 2. Mail delivery

### Address: 123456@abc.com

Subject: Meeting materials
Document data: Acquire from process 1

When the user finishes setting the workflow, the workflow execution request device 200 creates flow definition information as illustrated in FIG. 5A. Note that descriptions that are unimportant for explaining the flow definition information are omitted from the figure.

The flow definition information is described in, for example, XML. One workflow is defined from <flows> to </flows>. Furthermore, the procedures of the workflow are defined from <flow> to </flow>.

Each process is described in units of one <plug-in id> tag, and it is described what kind of process is being performed. For example, plug-in id=“ToSMTP” means a process of sending an e-mail, and type=“output” means that the process type of data is output. displayName=“mail delivery” is a process name displayed when the user views the operation panel. plug-in id=“PDFConverter” means a process of converting the job data into PDF, and type=“filter” means that the process type of the data is conversion. displayName=“PDF conversion” is a process name displayed when the user views the operation panel.

Furthermore, <nextPlug-in id> is a tag for instructing the order of the processes. For example, it is defined that the process after PDF conversion is mail delivery. Accordingly, the service providing device 300 can determine the next process (more specifically, the service providing device 300 can identify the next service providing device, as illustrated in FIG. 5B).

The <start_point> tag defines the first process for starting the workflow. That is to say, the process that the user has defined to be executed at the beginning of the workflow, is defined.

According to the flow definition information of FIG. 5A, it is understood from the <start_point> tag, that the first process is PDF conversion, and that the next process after PDF conversion is mail delivery.

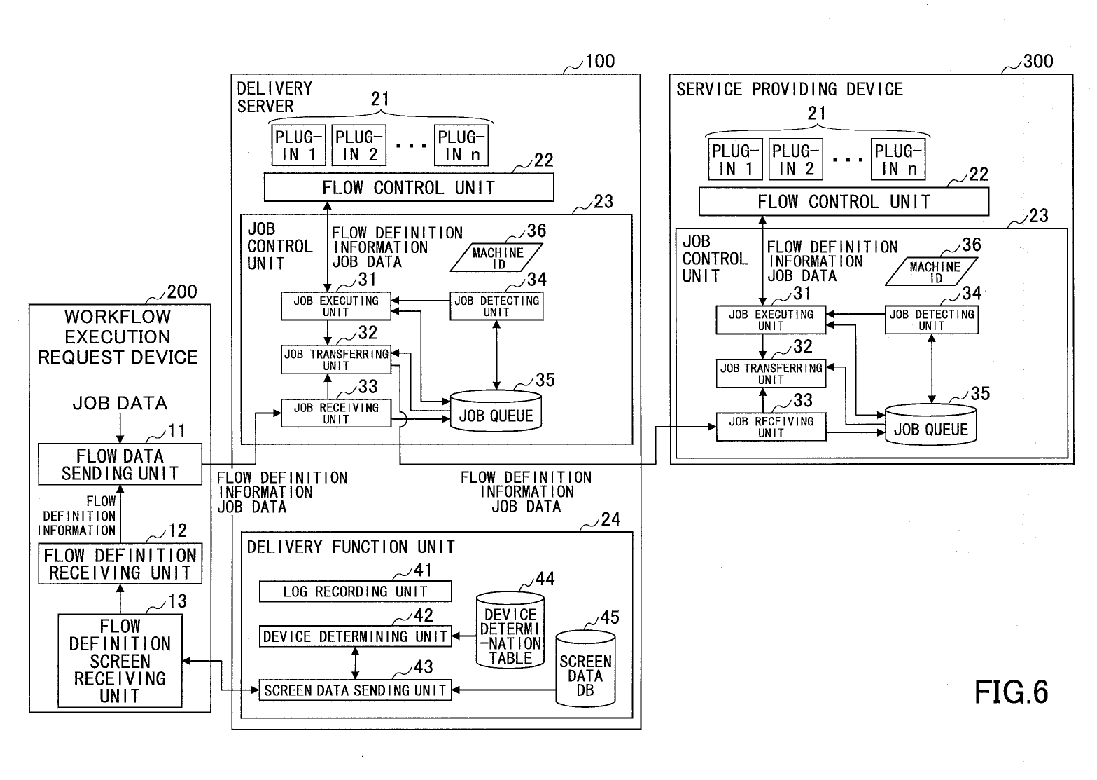

The delivery server 100 analyzes the flow definition information of FIG. 5A, adds a proceed attribute in units of <plug-in id> tags, and adds a <current_point> tag to the flow definition information. The delivery server 100 includes a device determination table 44 described below (see FIG. 6, etc.), in which the service providing device that can perform the process of the plug-in id is associated to each <plug-in id> tag. For example, the delivery server 100 refers to the device determination table 44, and determines that the device to perform mail delivery is “machineID A”, and that the device to perform PDF conversion is “machineID B”. FIG. 5B illustrates an example of flow definition information updated by the delivery server 100.

Note that the workflow execution request device 200 may perform the operations up to determining the service providing devices 300 for performing the respective processes. As long as the device determination table 44 is included in the workflow execution request device 200, or the workflow execution request device 200 can access the device determination table 44, the determining of the device may be performed by either the workflow execution request device 200 or the service providing device 300.

FIG. 5C is for describing an example of a <current point> tag. The <current_point> tag indicates the process to be processed at the current time point in the workflow, i.e., the process to be processed next. The delivery server 100 refers to the <start_point> tag to determine the process to be performed first, and describes in the flow definition information that PDF conversion is the process to be process next, as illustrated in FIG. 5B. Note that the process of the <current_point> tag is referred to as the process of the current point. The <current_point> tag may be included at the time point when the workflow execution request device 200 sends information to the delivery server 100. In this case, the <current_point> tag is the same as the <start_point> tag.

The service providing device 300 refers to the proceed attribute and the <current point> tag, and determines whether the device itself (self-device) is to perform the process. Furthermore, when the process is performed, the service providing device 300 updates the <current point> tag, and sends the flow definition information and the job data to the next service providing device 300. For example, when PDF conversion is completed, the <current_point> tag is updated as follows.

<current point>

<plug-in id=“ToSMTP”/>

</current_point>

Furthermore, in FIGS. 5A and 5B, only one plug-in id is described in the <nextPlug-in id> tag. However, depending on the workflow set by the user, a plurality of processes may be processed in parallel. For example, when the job data is to be sent by e-mail and also stored in a document box, the sending of the e-mail and the sending of the document box can be executed in parallel. In such a workflow, there may be two or more plug-in Ids described in the <nextPlug-in id> tag. In this case, the delivery server 100 creates flow definition information in which “ToSMTP” is described in the <current point> tag, and flow definition information in which “DocBox” (document box) is described, and sends the created flow definition information to the service providing device 300.

Example of Functional Block

FIG. 6 is an example of a functional block diagram of the workflow execution request device 200, the delivery server 100, and the service providing device 300.

The workflow execution request device 200 includes a flow data sending unit 11, a flow definition receiving unit 12, and a flow definition screen receiving unit 13. The flow definition screen receiving unit 13 accesses the delivery server 100 and receives screen data for defining the workflow. Note that the IP address or the URL of the delivery server 100 is already known to the workflow execution request device 200. For example, the screen data is described in XML. The flow definition screen receiving unit 13 receives XML and a XSLT style sheet, converts this into HTML, and displays the converted data on the operation panel 125. The flow definition receiving unit 12 receives the setting of the workflow set by the user and creates flow definition information. The flow data sending unit 11 sends the flow definition information and the job data specified by the flow definition information, to the delivery server 100. Note that the job data may be instructed as a user explicitly specifies a file name; or the job data may be created in the workflow by scanning an original document or image pickup by a camera. In the present embodiment, as a matter of convenience, the former case is described.

The delivery server 100 includes one or more plug-ins 21, a flow control unit 22, a job control unit 23, and a delivery function unit 24. The delivery function unit 24 is a function of the delivery server 100 for preparing and supporting a workflow. The delivery function unit 24 includes a log recording unit 41, a device determining unit 42, and a screen data sending unit 43. The screen data sending unit 43 reads screen data from a screen data DB 45 and sends the screen data to the workflow execution request device 200, in response to a request from the workflow execution request device 200.

The device determining unit 42 refers to the device determination table 44 during communications with the workflow execution request device 200, and determines the device to execute each process. For example, the screen data sending unit 43 receives flow definition information set by the user, and when sending a confirmation screen of the final workflow, the device is to be determined. Alternatively, the device may be determined with respect to flow definition information received by a job receiving unit 33.

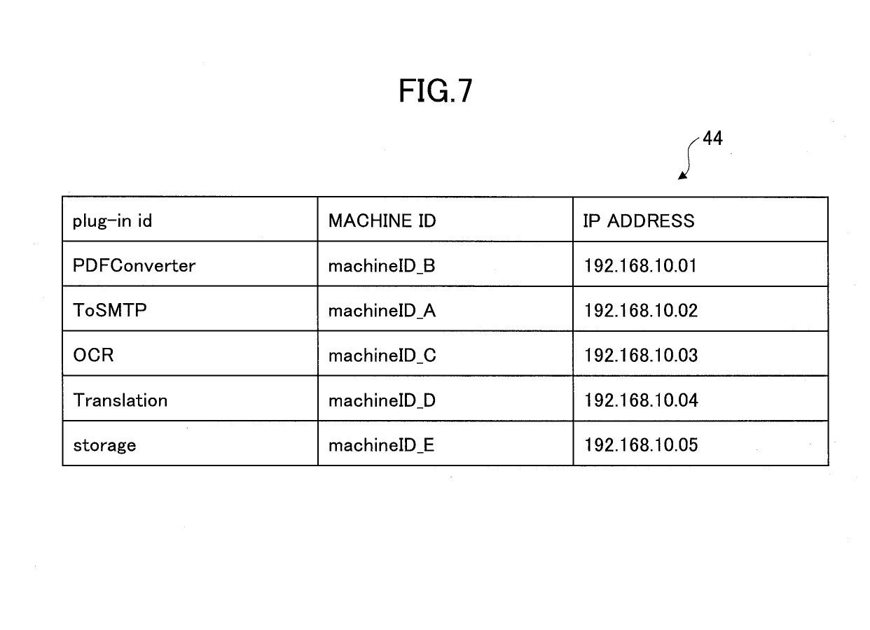

FIG. 7 illustrates an example of the device determination table 44. The machine ID and the IP address of the service providing device 300 that can execute, the process are registered. An IP address is assigned by a DHCP server (not shown), and when the machine ID is known, the IP address can be identified. Furthermore, in a case where a unique IP address is assigned to the service providing device 300, the IP, address may be used as the machine ID. The device determining unit 42 identifies the machine ID of the device that can execute the process based on the plug-in id, and adds the machine ID as a proceed attribute. When a plurality of machine IDs are registered for a single plug-in id, for example, a service providing device having low processing load may be selected from the service providing devices 300, or the service providing device 300 having the same network address may be prioritized in the selection.

Furthermore, before the user performs the operation of starting to execute the workflow, for example, the delivery server 100 may determine whether the service providing device 300 has been activated, and assign the process to the service providing device 300 that is activated. Accordingly, it is possible to prevent situation where a large proportion of the workflow cannot be executed after receiving an execution start operation from the user.

Referring back to FIG. 6, the log recording unit 41 records the log of the workflow. When the process of the self-device ends, the service providing device 300 sends the execution result to the delivery server 100, and therefore the log recording unit 41 can record, in units of workflows, the identification information of the device that executed each process, the start time, the end time, and whether the process has been completed or the process has been unsuccessful. In a case where the delivery server 100 has executed the process, the log recording unit 41 of the self-device records the execution result.

The job control unit 23 controls the execution of each process of the workflow. First, the job receiving unit 33 receives flow definition information and job data from another deVice (in the case of the delivery server 100, the delivery server 100 and the service providing device 300; in the case of the service providing device 300, the delivery server 100 or another service providing device 300), and accumulates the information in a job queue 35. A single job corresponds to a single process to which a single Plug-in id has been assigned.

The job receiving unit 33 determines whether the flow definition information and the job data of the workflow temporarily stored in the job queue 35, need to be processed at the self-device. That is to say, the job receiving unit 33 determines Whether a machine ID 36 of the self-device is registered in at least one Proceed attribute.

When the machine ID 36 of the self-device is not registered in a Proceed attribute, a job transferring unit 32 sends the flow definition information and the job data to the service providing device 300. This service providing device 300 is preferably a service providing device that is in charge of the process of the <current_point>; however, there is no problem even if the information is sent to a service providing device that is not in charge of the process of the <current_point>, because the information is transferred to a service providing device that is in charge of the process of the <current_point>.

When the machine ID 36 of the self-device is registered in a Proceed attribute, a job executing unit 31 reads the flow definition information and the job data from the job queue 35 and executes the process. The job executing unit 31 confirms the <current_point>, and confirms the delivery server 100 or the service providing device 300 that is to perform the process of <current_point>. When the self-device is the device to perform the process of <current point>, the job executing unit 31 outputs the flow definition information and the job data to the flow control unit 22. When the self-device is not the device to perform the process of <current point>, the job executing unit 31 causes the job transferring unit 32 to transfer the flow definition information and the job data. The transfer destination is preferably a service providing device 300 that is in charge of the process of <current_point>.

The flow control unit 22 selects a plug-in 21 in line with the flow definition information, and executes the process. The plug-in 21 is, for example, for performing PDF conversion, for sending an e-mail, performing an OCR process, and performing translation, as described above. The plug-in 21 can operate on a common platform, and the delivery server 100 and the service providing device can separately add or delete a single plug-in 21. The plug-ins do not interfere with each other's processes. Note that the process is not limited to being performed by the plug-in 21 as described above; the process may be performed by an application program.

The flow control unit 22 confirms the process of <current_point>, calls the plug-in 21 to perform the confirmed process, and causes the plug-in 21 to execute a job. When the job is normally completed, the flow control unit 22 updates the process of the <current point> tag. The job executing unit 31 stores the flow definition information and the job data in the job queue 35.

A job detecting unit 34 detects that a job has been input to the job queue 35. That is to say, when job data, which has been created by a single process executed by the plug-in 21, is stored in the job queue 35, the job detecting unit 34 detects this. Then, the job executing unit 31, etc., repeats the same process.

As illustrated in FIG. 6, the service providing device 300 includes one or more plug-ins 21, the flow control unit 22, and the job control unit 23. That is to say, the providing device 300 does not include a delivery function unit 24, but other functions are the same as those of the delivery server 100. This means that the service providing device 300 and the delivery server 100 perform the same executing procedures of the workflow, which indicates that the development cost of the service providing device 300 can be reduced and it is possible to flexibly switch between the service providing device 300 and the delivery server 100.

Operation Procedures

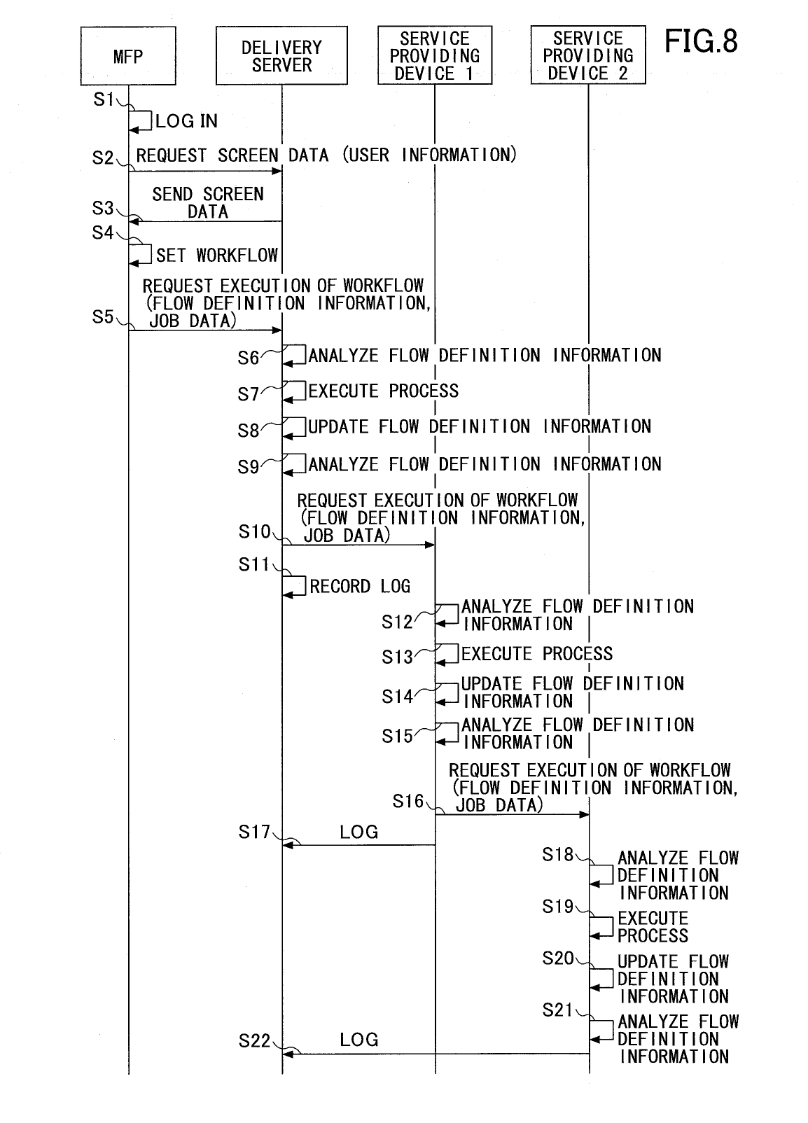

FIG. 8 illustrates an example of overall operation procedures by the process executing system 500.

S1: The user logs into the MFP 201. The log in operation is described below; a user name and a password are input, an IC card is read, to log in.
S2: According to the user's operation, the MFP 201 requests the delivery server 100 to provide screen data of the workflow. At this time, the user information is also sent.
S3: The screen data sending unit 43 of the delivery server 100 sends the screen data to the MFP 201.
S4: When the user sets the contents of the workflow in the MFP 201, the flow definition receiving unit 12 creates the flow definition information of the workflow.
S5: When the user performs the operation to start executing the final workflow, the flow data sending unit 11 sends the flow definition information and the job data to the delivery server 100. Note that it is assumed that the delivery server 100 or the MFP 201 has determined the device to execute each process, before receiving the flow definition information and the job data.
S6: The job receiving unit 33 of the delivery server 100 stores the flow definition information and the job data in the job queue 35, and analyzes the flow definition information. This analysis involves two operations, i.e., determining whether the self-device is described as the device to perform the process, and determining whether the current point is indicating the process of the self-device.
S7: As a result of the analysis, when the self-device is to perform the process, the flow control unit 22 uses the plug-in 21 to execute the process assigned to the self-device.
S8: The flow control unit 22 changes the current point to the next process, and updates the flow definition information.
S9: Next, the job executing unit 31 analyzes the flow definition information, and identifies the service providing device 300 to perform the next process.
S10: The job transferring unit 32 sends the flow definition information and the job data to the service providing device 1 to perform the next process.
S11: The job control unit 23 sends the execution result of the process performed by the self-device, to the delivery server 100. In this case, the delivery server 100 has performed the process, and therefore the execution result is to be output to the log recording unit 41.
S12 through S17: Hereafter, the processing procedures performed by the service providing device 1 are the same as the processing procedures performed by the delivery server 100.
S18 through S22: The processing procedures performed by the service providing device 2 are the same as the processing procedures performed by the delivery server 100.
As described above, the processing procedures of the workflow can be made the same among the devices.

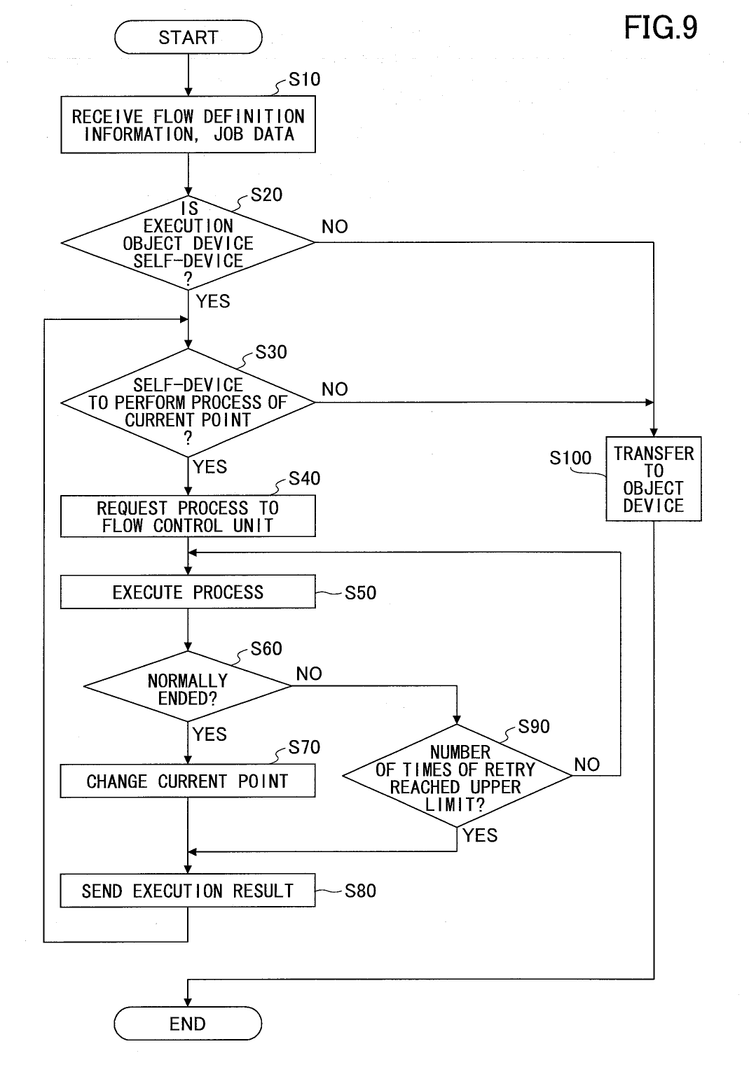

FIG. 9 is an example of a flowchart indicating the procedures when the delivery server 100 or the service providing device executes a process. FIG. 9 indicates the detailed procedures of steps S6 through S11 of FIG. 8.

First, the job receiving unit 33 receives the flow definition information and the job data, and receives a workflow execution request (step S10).

The job receiving unit 33 determines whether the self-device as an execution object device, based on whether the machine ID of the self-device is registered in the proceed attribute of the flow definition information (step S20).

When the self-device is not an execution object device (NO in step S20), the job transferring unit 32 transfers the flow definition information and the job data, so that another service providing device can execute the process (step S100).

When the self-device is an execution object device (YES in step S20), the job executing unit 31 determines whether the process of the current point is a process to be performed by the self-device (step S30).

When the process of the current point is not a process to be performed by the self-device (NO in step S30), the job transferring unit 32 transfers the flow definition information and the job data, so that another service providing device 300 can execute the process (step S100). When the entire workflow has ended, the information does not need to be transferred. Furthermore, it is preferable to send a message indicating that the entire workflow has ended to the delivery server 100.

When the process of the current point is a process to be performed by the self-device (YES in step S30), the job executing unit 31 requests the flow control unit 22 to perform the process (step S40).

The flow control unit 22 confirms the current point, identifies the process to be performed by the self-device, and executes the process by calling a corresponding plug-in 21, etc. (step S50). The plug-in 21 returns the execution result of the process to the flow control unit 22.

The flow control unit 22 determines whether the process has normally ended, or whether the process did not normally end when the plug-in 21 has explicitly notified an occurrence of an error or when there is no response (step S60).

When the process has not ended normally (NO in step S60), the flow control unit 22 determines whether the number of times of a retry has reached the upper limit (step S90). When the number of times of a retry has not reached the upper limit (NO in step S90), the process returns to step S50, and the plug-in 21 performs the same process again.

When the number of times of a retry has reached the upper limit (YES in step S90), the process proceeds to step S80, and the job control unit 23 sends the execution result (step S80). In this case, the execution result includes the plug-in ID of the process and information indicating that the process has not ended normally.

When the process has ended normally (YES in step S60), the flow control unit 22 changes the current flow to update the flow definition information (step S70).

Next, the job control unit 23 sends the execution result (step S80). In this case, the execution result includes the plug-in ID of the process and information indicating that the process has ended normally.

Subsequently, the process returns to step S30, and according to need, the flow control unit 22 performs the process again.

As described above, in the process executing system 500 according to the present embodiment, the delivery server 100 and the service providing device 300 have a function of processing the work flow, and therefore jobs can be transferred one right after the other. Thus, the job data, etc., does not need to be returned to the delivery server 100 for each process, and the interaction between the delivery server 100 and the service providing device can be reduced so that the job process can be performed efficiently.

### Second Embodiment

In the second embodiment, a description is given of the process executing system 500 in which the service providing devices 300 are provided across a firewall.

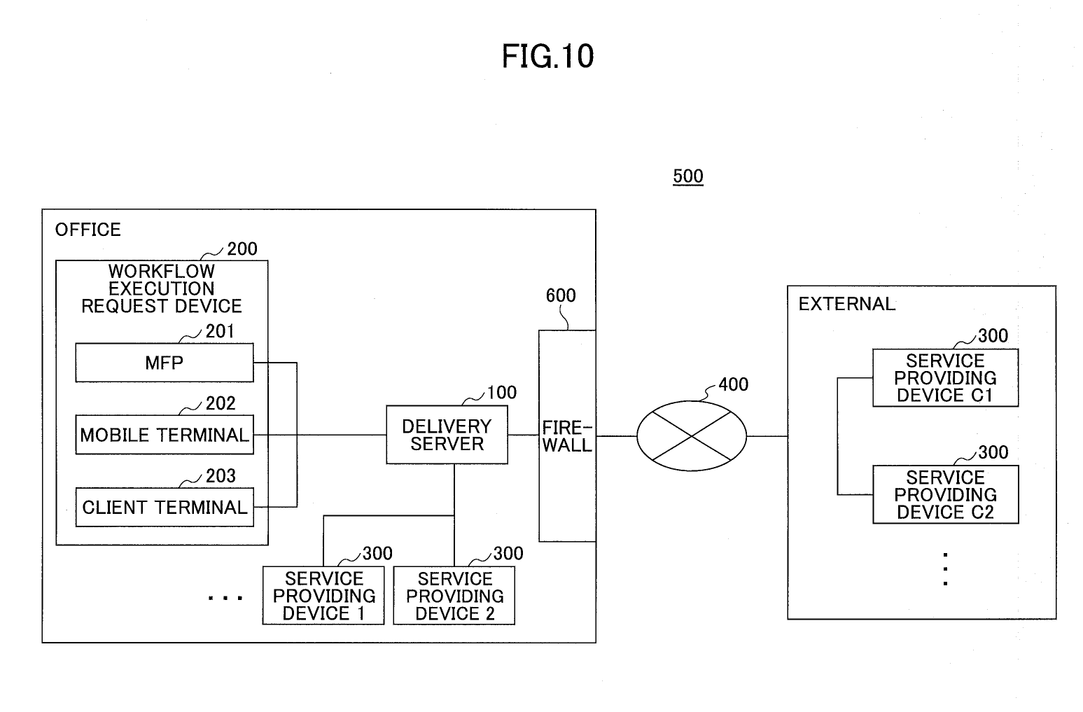

FIG. 10 illustrates a system configuration of the process executing system 500. Note that in the present embodiment, elements that are denoted by the same reference numerals as those of the first embodiment have the same functions as the elements of the first embodiment, and therefore the main configuration of the present embodiment may only be described.

The process executing system 500 is divided into an office side and an external side via a firewall 600. The configuration of the office side is substantially the same as that of the first embodiment. The external side includes one or more service providing devices 300 via a network (Internet). The service providing device includes the flow control unit 22, the job control unit 23, and one or more plug-ins 21, similar to the first embodiment.

In the system format as described above, the user is in present in the office side, and therefore when job data processed by the service providing device 300 of the external side is acquired by the delivery server 100 of the office side, the data is to be acquired through the firewall 600. It is difficult to acquire data through the firewall 600 according to communications started by a device on the external side, and therefore the delivery server 100 monitors the service providing device 300 on the external side. According to the monitoring, it is possible for the delivery server 100 to receive job data from a service providing device 300 on the external side.

Monitoring means that the delivery server 100 periodically confirms the execution result with an external service providing device 300 (in a communication state where responses from outside can be received). The access control of the firewall 600 includes, for example, packet filtering and state-full inspection. With these access control methods, it is possible to make a setting for allowing the passage of a response from a destination IP address, to a packet sent to the destination IP address from the office side by an administrator (the transmission source IP address of communication from outside is the address IP address set in the communication from the office). According to a firewall 600 having such a setting, as a response to a packet sent by the delivery server 100 of the office side, flow definition information and job data can be received.

Creation of Flow Definition Information

In the present embodiment, the flow definition information needs to be created by a different format to that of the first embodiment. This is because the delivery server 100 requires flow definition information for monitoring an external service providing device 300.

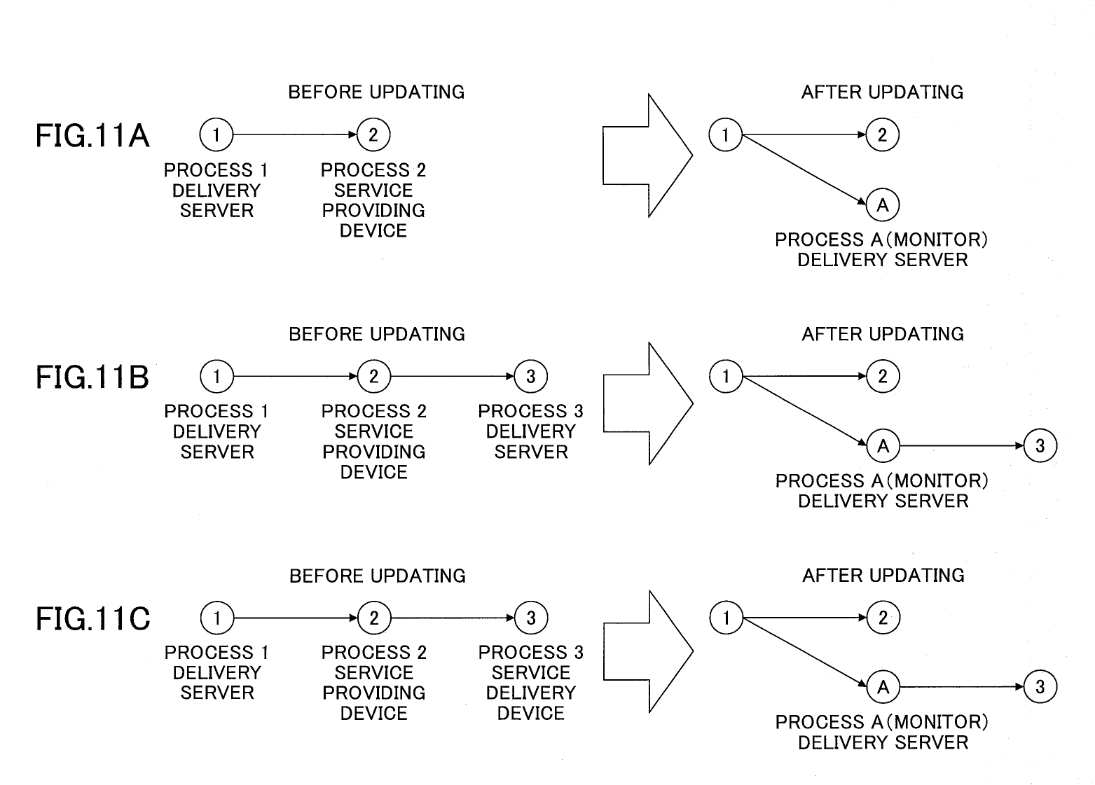

FIGS. 11A through 11C schematically illustrate an example of the creating of flow definition information. The flow definition information before updating of FIG. 11A includes the following contents. The processing contents may include any content, and part of the processing may be performed by an external service providing device 300.

Process 1 (circle 1): Delivery server
Process 2 (circle 2): External service providing device C1

The delivery server 100 updates the flow definition information after executing process 1 (change current point to next process), and creates flow definition information that is separate from the flow definition information that is updted.

The flow definition information to be created is used by the delivery server 100 for monitoring the external service providing device C1. The latter flow definition information is created as follows. The delivery server 100 copies the flow definition information, and adds the following contents to the <plug-in id> tag.

<plug-in id=“Monitor” . . . proceed=“machineIDA (delivery server)”/>
That is to say, an indication that the delivery server 100 will perform the monitoring process is added. The device that performs the monitoring process is determined in advance (in this case, the delivery server), and the machine ID of a device determined in advance is described in the proceed attribute of the <plug-in id> tag.

Furthermore, the delivery server 100 changes the description of <current_point> to <plug-in id=“Monitor”/>. That is to say, the delivery server 100 changes the description to indicate the next process is monitoring.

By the above updating operation, as illustrated in the after updated state of FIG. 11A, the flow definition information of process 2 (circle 2) is sent to the external service providing device C1, and the flow definition information of process A (circle A) is executed by the delivery server 100. Note that the flow definition information of process A (circle A) is discarded when the monitoring ends, because the next process is not described.

In the following, the flow definition information updated by the flow control unit 22 is referred to as the original flow definition information, and the flow definition information created by the delivery server 100 is referred to as the flow definition information used for monitoring.

The flow definition information before updating of FIG. 11B includes the following contents.

Process 1: Delivery server
Process 2: External service providing device C1
Process 3: Delivery server

The processes up to process 2 are the same as those of FIG. 11A; however, in the next process, the delivery server 100 performs process 3. As indicated in the updated flow definition information of FIG. 11A, the external service providing device C1 executes process 2, and the delivery server 100 monitors the process of the external service providing device C1. After executing process 2, the external service providing device C1 updates the flow definition information, and sends the flow definition information together with the job data to the delivery server 100 that is performing the monitoring. Therefore, the delivery server 100 can receive the updated flow definition information and job data through the firewall 600. In <current point> of the flow definition information updated by the external service providing device C1, it is described that the delivery server 100 performs process 3, and therefore the delivery server 100 can execute the process of the workflow in the same manner as the first embodiment.

The flow definition information before updating of FIG. 11C includes the following contents.

Process 1: Delivery server
Process 2: External service providing device C1
Process 3: Internal service providing device 1

The processes up to process 2 are the same as those of FIG. 11A; however, in the next process, the service providing device 1 of the office side performs process 3. In this case also, the delivery server 100 monitoring the external service providing device C1 receives the updated flow definition information and job data through the firewall 600. In <current_point> of the flow definition information updated by the external service providing device C1, it is described that the service providing device 1 on the office side performs process 3. Therefore, the delivery server 100 analyzes the flow definition information and finds that the self-device is not the device to perform the process, and thus transfers the flow definition information and the job data to the service providing device 1 of the office side.

As described above, flow definition information is created for the delivery server 100 on the firewall 600 side to monitor the process of the external service providing device, so that the workflow can be executed across the firewall 600.

Note that the monitoring by the delivery server 100 is part of the workflow, and therefore the plug-in 21 may execute the process. Therefore, it is not only easy to add a function to the delivery server 100, but it is also easy to add a monitoring function to the service providing device 300. As a matter of course, a function for monitoring may be installed separately from the plug-in 21,

Operation Procedures

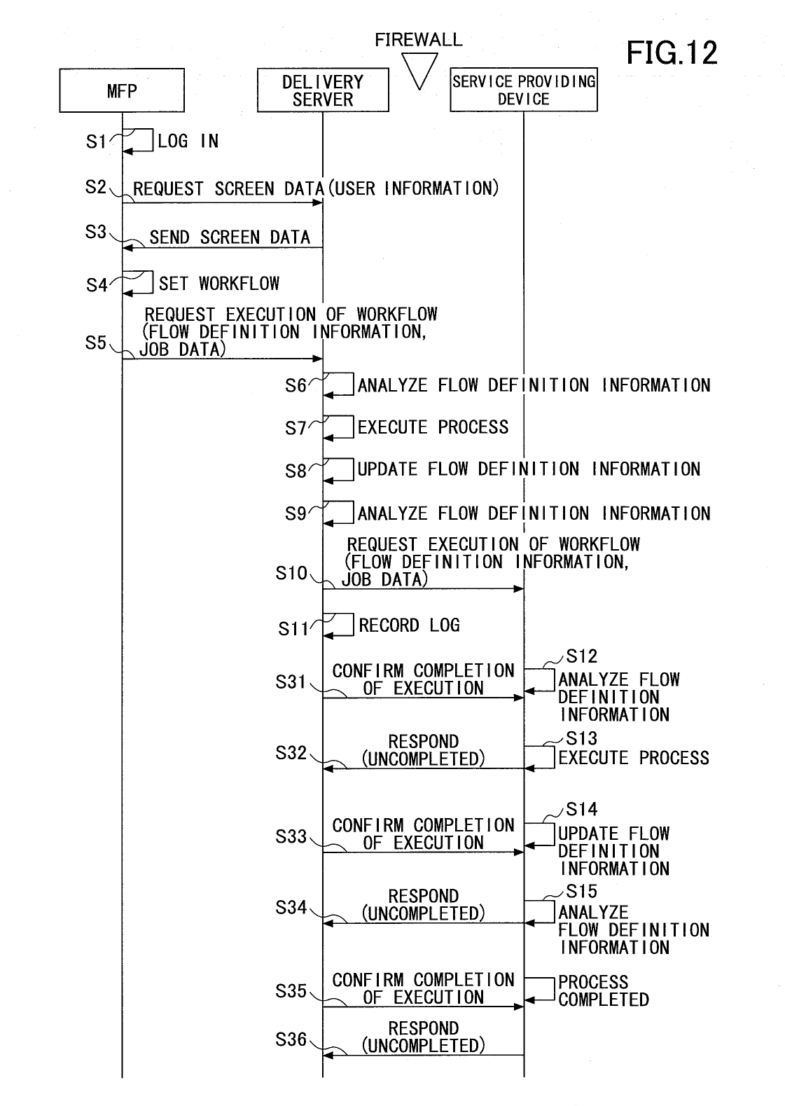

FIG. 12 illustrates an example of overall operation procedures by the process executing system 500. In this example, a description is given of a case of processing the workflow of FIG. 11A.

S1: The user logs into the MFP 201. The log in operation is described below; a user name and a password are input, an IC card is read, to log in.
S2: According to the user's operation, the MFP 201 requests the delivery server 100 to provide screen data of the workflow. At this time, the user information is also sent.
S3: The screen data sending unit 43 of the delivery server 100 sends the screen data to the MFP 201.
S4: When the user sets the contents of the workflow in the MFP 201, the flow definition receiving unit 12 creates the flow definition information of the workflow. At this time, the user does not have to consider whether the process is to be performed outside or inside the office. However, as a matter of security, the MFP 201 may confirm this with the user. For example, the MFP 201 may display a message such as “The selected process A will be executed on the Internet. Is this OK?”, and as the user presses a “YES” button, the workflow is received. Accordingly, security can be maintained.
S5: When the user performs the operation to start executing the final workflow, the flow data sending unit 11 sends the flow definition information and the job data to the delivery server 100. Note that the delivery server 100 determines the device to execute each process, before receiving the final flow definition information and the job data.
S6: The job receiving unit 33 of the delivery server 100 stores the flow definition information and the job data in the job queue 35, and analyzes the flow definition information. This analysis involves two operations, i.e., determining whether the self-device is described as the device to perform the process, and determining whether it is the timing for the self-device to perform the process.
S7: As a result of the analysis, when the self-device is to perform the process, the flow control unit 22 uses the plug-in 21 to execute the process assigned to the self-device.
S8: The flow control unit 22 changes the current point to the next process, and updates the flow definition information.
S9: Next, the job executing unit 31 analyzes the flow definition information, and identifies the service providing device to perform the next process. In this case, the service providing device to perform the next process is the external service providing device C1. For example, the job transferring unit 32 refers to the IP address of the service providing device to perform the process of <current point>, and detects that the device is outside. Alternatively, a table in which a list of machine IDs of external service providing devices are registered in advance may be held, and the job transferring unit 32 may detect that an external service providing device C1 performs the process.

When a service providing device C1 outside the firewall 600 executes a process, the job executing unit 31 copies the flow definition information, adds the process of monitoring to the <plug-in id> tag, and changes the description of <current_point> to monitoring. Accordingly, two sets of flow definition information are attained.

As a result, the job executing unit 31 analyzes the flow definition information for monitoring, and detects that the device that performs the next process is the delivery server 100 which is the self-device. Therefore, the flow control unit 22 uses the plug-in 21 to execute a monitoring process again.

S10: The job transferring unit 32 sends the original flow definition information and the job data to the service providing device C1 to perform the next process.
S11: The job control unit 23 sends the execution result of the process performed by the self-device, to the delivery server 100. In this case, the delivery server 100 has performed the process, and therefore the execution result is to be output to the log recording unit 41.
S12 through S17: Hereafter, the external service providing device C1 executes the process by the same procedures.
S31: The delivery server 100 periodically inquires the external service providing device C1 whether execution has been completed, by processing of the plug-in 21.
S32: The external service providing device C1 that has not completed execution sends a response indicating uncompleted to the delivery server 100.
S33: The delivery server 100 periodically inquires the external service providing device C1 whether execution has been completed, by processing of the plug-in 21.
S34: The external service providing device C1 that has not completed execution sends a response indicating uncompleted to the delivery server 100.
S35: The delivery server 100 periodically inquires the external service providing device C1 whether execution has been completed, by processing of the plug-in 21.
S36: The external service providing device C1 that has completed execution sends a response indicating completed to the delivery server 100. In the present embodiment, the workflow ends here; however, when there is a next process, the delivery server 100 receives flow definition information and job data from the service providing device C1. As described above, the delivery server 100 can execute a workflow by using a service providing device 300 outside the firewall 600.

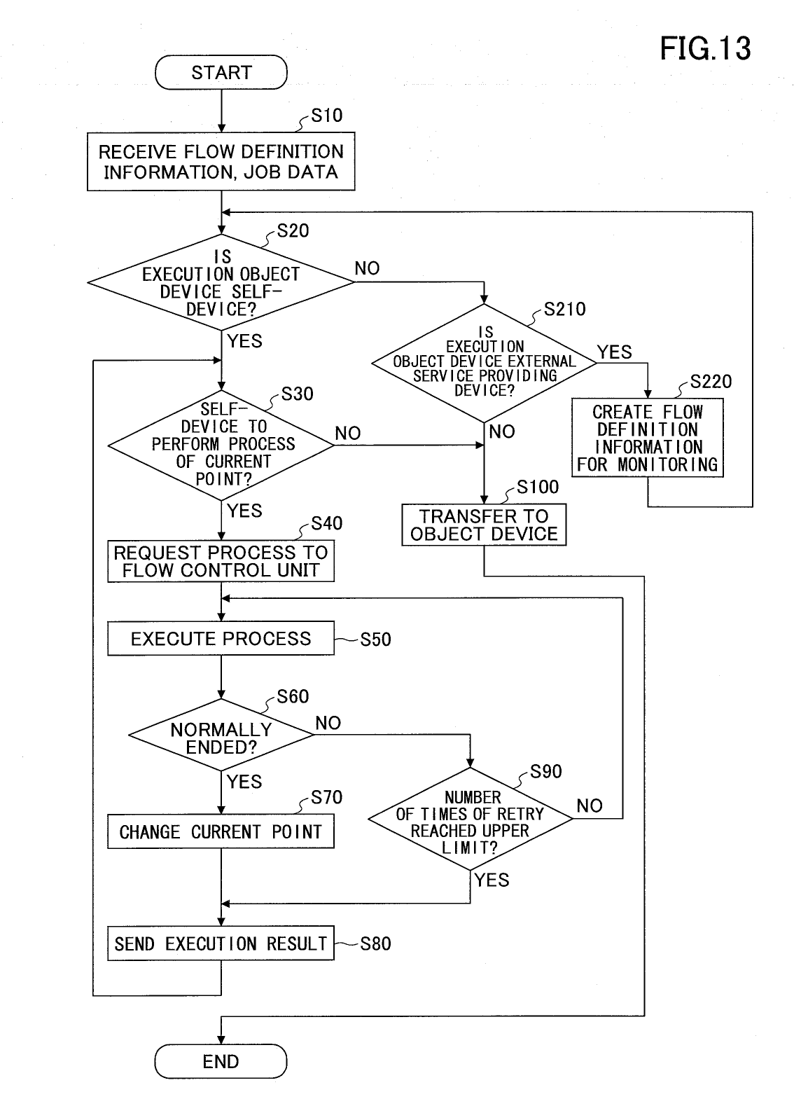

FIG. 13 is an example of a flowchart indicating the procedures when the delivery server 100 or the service providing device 300 executes a process. FIG. 13 is the same as FIG. 9, except that the processes of steps S210 and S220 are different from FIG. 9.

The job receiving unit 33 determines whether the self-device as an execution object device, based on whether the machine ID of the self-device is registered in the proceed attribute of the flow definition information (step S20).

When the self-device is not an execution object device (NO in step S20), the job control unit 23 determines whether the execution object device is an external service providing device (step S210).

When the execution object device is not an external service providing device (NO in step S210), the job transferring unit 32 transfers the flow definition information and the job data so that another service providing device can execute the process (step S100).

When the execution object device is an external service providing device (YES in step S210), the job control unit 23 creates flow definition information for monitoring (step S220). Subsequently, the process returns to step S20, and a process based on the flow definition information for monitoring is executed. When another device performs the monitoring, the flow definition information for monitoring is transferred at step S100.

According to the process executing system 500 of the present embodiment, the workflow can be executed by using a device outside the firewall 600, and therefore various high-level services can be provided. Furthermore, the monitoring can be executed as part of the workflow.

### Third Embodiment

In the third embodiment, a description is given of a process executing system 500 for performing user authentication. Note that the user authentication is applicable to both the first and second embodiments.

Example of Functional Block

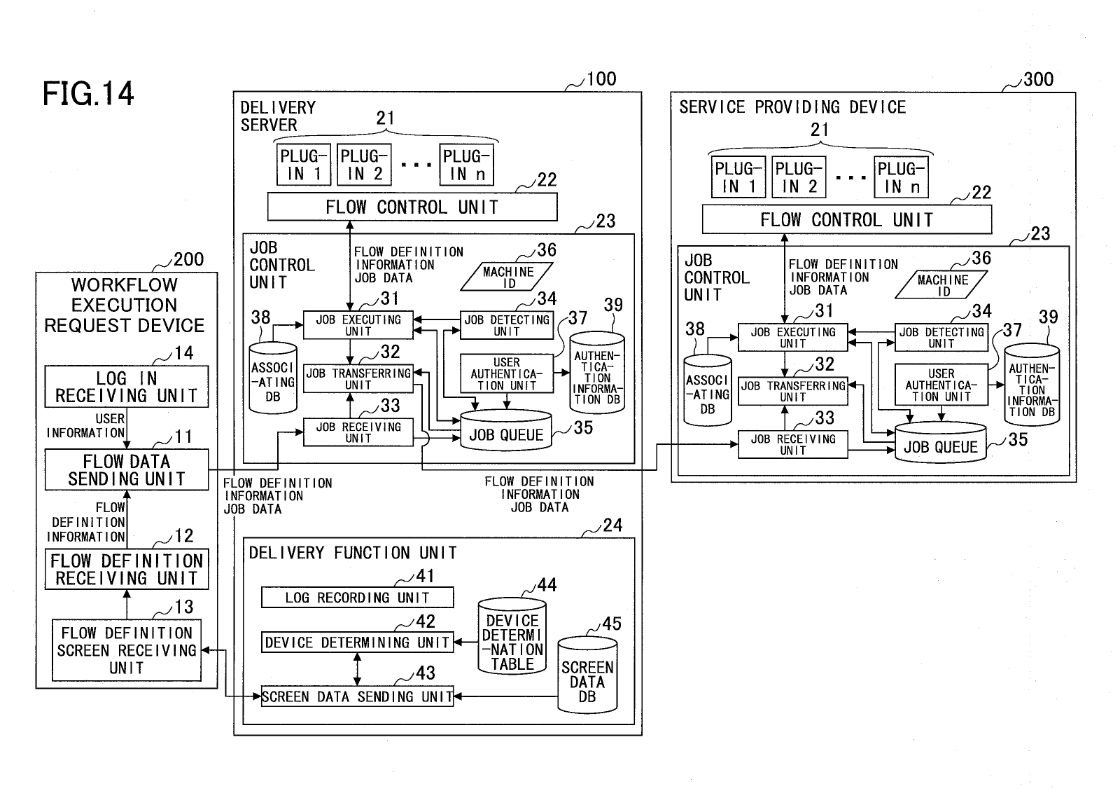

FIG. 14 is an example of a functional block diagram of the workflow execution request device 200, the delivery server 100, and the service providing device. Note that in the present embodiment, elements that are denoted by the same reference numerals as those of the first and second embodiments have the same functions as the elements of the first and second embodiments, and therefore the main configuration of the present embodiment may only be described.

In the present embodiment, the workflow execution request device 200 includes a log in receiving unit 14, and the job control unit 23 includes a user authentication unit 37, an associating DB 38, and an authentication information DB 39. Note that the associating DB 38 and the authentication information DB 39 do not need to be provided in the device, as long as they are provided at locations that can be accessed by the delivery server 100 or the service providing device 300. The associating DB 38 stores association information for associating the device and the user information described below. The authentication information DB 39 stores authentication information of the user of each device. The user authentication unit 37 determines whether authentication of the user is established according to the consistency between the user information included in the flow definition information and the user information stored in the authentication information DB 39.

The log in receiving unit 14 of the workflow execution request device 200 receives log in from the user. When logging in, the user inputs the user name and password for making the workflow execution request device 200 accept the log in of the user. By the user name and password, the user can log into the workflow execution request device 200; however, the authentication information of the delivery server 100 and the service providing device 300 may be different from the user information. It is difficult for the user to send the user information to the delivery server 100 and the service providing device 300, and therefore as described below, the delivery server 100 and the service providing device 300 changes the user information described in the flow definition information according to the circumstance. Note that the user information may be sent as a separate file from the flow definition information, instead of including the user information in the flow definition information.

Association Information

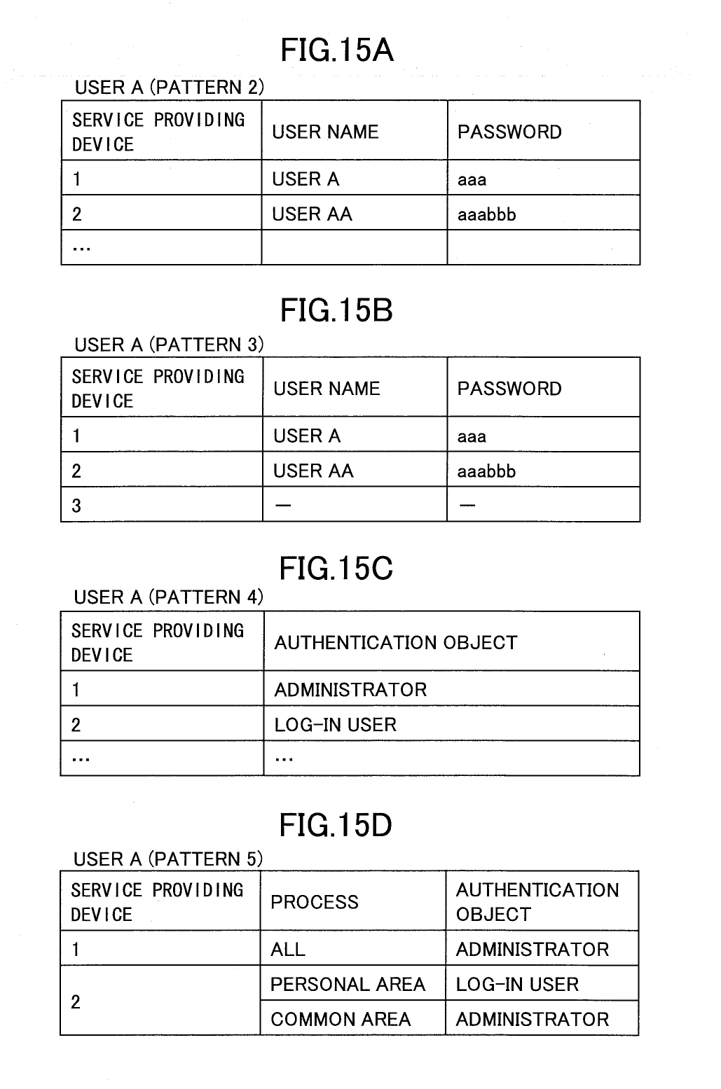

FIGS. 15A through 15D schematically illustrate examples of association information of various patterns.

Pattern 1. A case of using common user ID and common password for authentication at any of the devices

In pattern 1, the flow definition information is to include one pair of a common user ID and a common password. In this case, the user information in the flow definition information is fixed, and therefore a associating DB 38 is not used. The user ID and password may be those that are input in the workflow execution request device 200 by the user. Alternatively, a user ID and a password for the administrator may be used.

Pattern 2. A case where user ID and password are different according to device In this case, as illustrated in FIG. 15A, in the associating DB 38 of each device, a user ID and a password used for authentication by each service providing device 300 are stored. The job executing unit 31 identifies the service providing device 300 from the machine ID for performing the process of the current point, and reads the user ID and password. Then, the job executing unit 31 updates the user information in the flow definition information.

Pattern 3. A case where user ID and password are different according to device but authentication is unnecessary depending on device In this case, as illustrated in FIG. 15B, substantially the same information as that of pattern 2 is registered in the associating DB 38 of each device. As for devices that do not require authentication, “-” is set as the user name and password. When the service providing device 300 for performing the process of current point is a device that does not require authentication, “-” is described by the job executing unit 31 for the user name and password in the flow definition information.

Pattern 4. A case where object of authentication information is different according to device (for example, information of the administrator is used for a device and information of the log-in user is used for another device)

In this case, as illustrated in FIG. 15C, the authentication object is stored in the associating DB 38 of each device. The job executing unit 31 identifies the authentication object of the service providing device 300 that is to perform the process of the current point, collects the user name and password of the authentication object, and updates the user information of the flow definition information.

Pattern 5. A case where object of authentication information is different according to process of device (for example, the object of authentication information is different when saving in storage, saving in personal area, and saving in common area)

In this case, as illustrated in FIG. 15D, an authentication object is stored for each process of each device, in the associating DB 38. The job executing unit 31 identifies, from the associating DB 38, the service providing device 300 to perform the process of the current point and the object of authentication information associated with the plug-in ID of the current point. Furthermore, the job executing unit 31 collets the user name and password of the authentication object, and updates the user information of the flow definition information.

Example of Updating User Information

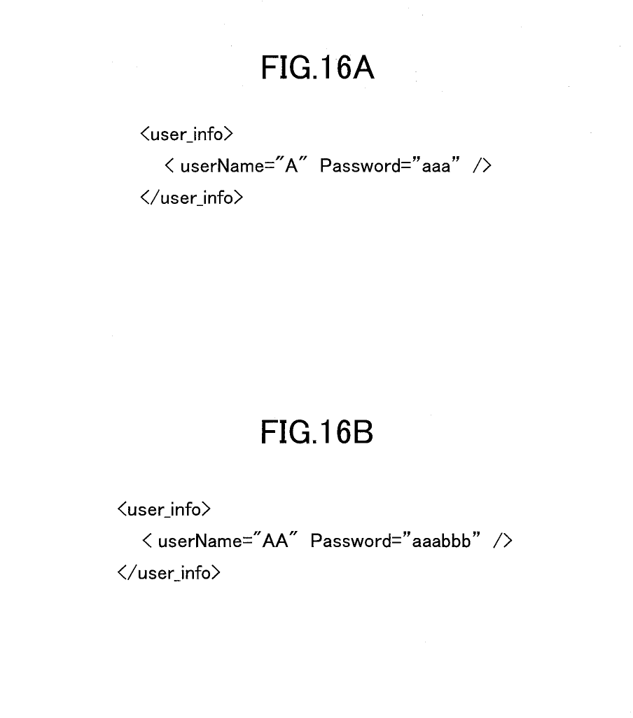

FIGS. 16A and 16B illustrate examples of user information in the flow definition information before and after being updated. FIG. 16A illustrates the user information before being updated, and FIG. 16B illustrates the user information after being updated. For example, the delivery server 100 authenticates the user by [userName=“A” Password=“aaa”], and executes the process. The job executing unit 31 of the delivery server 100 refers to the associating DB 38, and reads the user information of the service providing device 300 to perform the process of the current point. Then, the job executing unit 31 updates the user information of the flow definition information to <userName=“AA” Password=“aaabbb”/>. Accordingly, the authentication is established at the next service providing device 300, and the execution of the workflow can be continued.

Operation Procedures

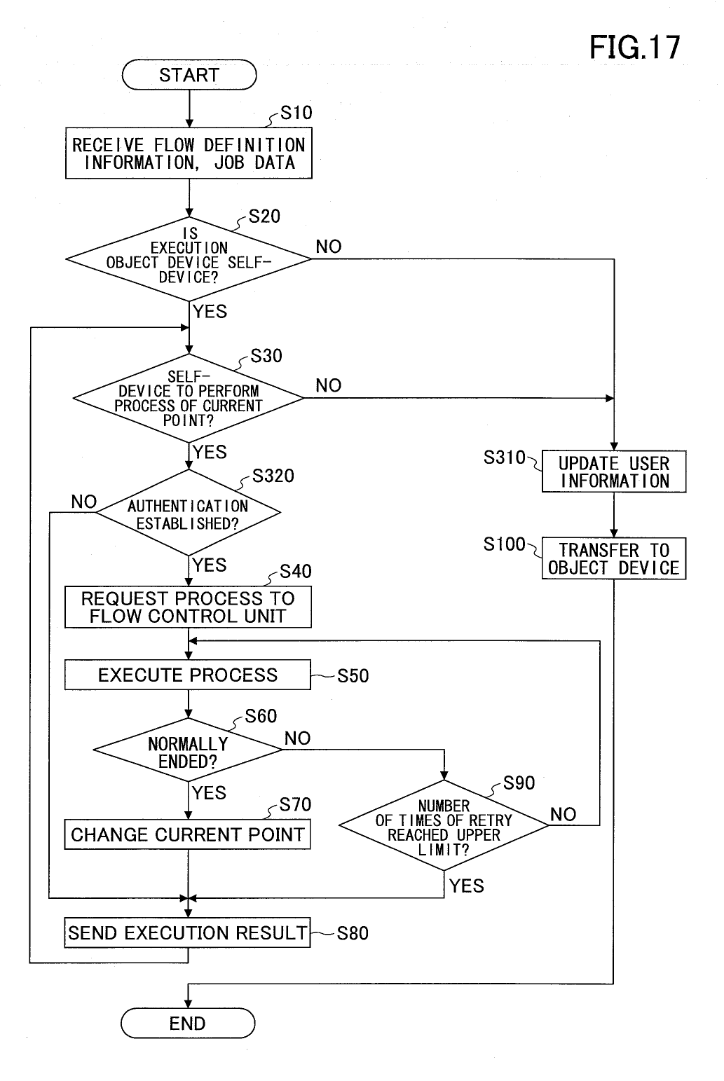

FIG. 17 is a flowchart of procedures performed when the delivery server 100 or the service providing device executes a process. FIG. 17 is the same as FIG. 9, except that steps S310 and S320 are added after step S20 or S30.

First, in step S30, when the self-device is the device to perform the process of the current point (YES in step S30), the user authentication unit 37 reads the user information of the flow definition information, and determines whether authentication is established based on whether the user information that has been read is consistent with the user information of the authentication information DB 39 (step S320). Only when the authentication is established, the process assigned to the self-device is executed. Note that when the authentication is not established, an error is sent to the delivery server 100 as the execution result (step S80).

Furthermore, when the self-device is not the execution object device (NO in step S20), or when the self-device is not the device to perform the process of the current point (NO in step S30), the job executing unit 31 updates the user information of the flow definition information (step S310). The job executing unit 31 identifies the service providing device 300 to perform the process of the current point, and reads the authentication information of the user in the identified device. Then, the job executing unit 31 updates the user information of the flow definition information.

Then, the job transferring unit 32 transfers the flow definition information and the job data (step S100). Subsequent processes are the same as those of the first embodiment.

According to the process executing system 500 of the present embodiment, the user can be authenticated at each device that is to execute the workflow, and therefore the workflow can be executed while maintaining security.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

According to one embodiment of the present invention, a process executing system, a process executing method, and an information processing device are provided, in which the efficiency of sending/receiving of data between devices is increased.

The process executing system, the process executing method, and the information processing device are not limited to the specific embodiments described herein, and variations and modifications may be made without departing from the scope of the present invention.

The present application is based on and claims the benefit of priority of Japanese Priority Patent Application No. 2013-001157, filed on Jan. 8, 2013, the entire contents of which are hereby incorporated herein by reference.

What is claimed is:

1. A process executing system comprising:
a first device configured to receive a plurality of processes and a setting of an execution order of the plurality of processes; and
at least one second device configured to execute the plurality of processes, wherein
the first device and the at least one second device are connected via a network, wherein
the first device includes a first sending unit configured to send, to the at least one second device, process definition information defining process contents of each of the plurality of processes and a next process to be executed subsequently in the plurality of processes, and process object data or instruction information of the process object data, and
the at least one second device includes
a receiving unit configured to receive the process definition information and the process object data or the instruction information of the process object data,
a process execution control unit configured to analyze the process definition information and determine whether the next process is to be executed at a self-device, which is the at least one second device in which the process execution control unit is included,
a process execution unit configured to execute the next process on the process object data when the process execution control unit determines that the next process is to be executed at the self-device,
a definition information updating unit configured to update the process definition information by changing a definition of one of the plurality of processes, which is defined to be processed after the next process according to the execution order, to be a new next process, and
a second sending unit configured to send the process definition information and the process object data to an other one of the at least one second device other than the self-device.

2. The process executing system according to claim 1, wherein in the process definition information,
identification information of the at least one second device to execute one of the plurality of processes, is associated with each of the plurality of processes, and
the process execution control unit determines whether the next process is to be executed at the self-device, based on whether the identification information of the at least one second device to execute the next process matches the identification information of the self-device, and whether the next process matches one of the plurality of processes with which the identification of the self-device is associated.

3. The process executing system according to claim 1, wherein
the process execution control unit determines whether the next process is to be executed at the self-device again, after the process execution unit executes the next process on the process object data and the definition information updating unit updates the process definition information, and
when the next process is determined to be executed at the self-device, the process execution unit executes the next process on the process object data, and
when the next process is determined not to be executed at the self-device, the second sending unit sends the process definition information and the process object data to the other one of the at least one second device other than the self-device.

4. The process executing system according to claim 2, wherein
when the process execution control unit determines that the other one of the at least one second device to execute the next process is outside a firewall, the process execution control unit creates second process definition information defining, as the next process, a monitoring process of monitoring execution of the next process performed by the other one of the at least one second device,
the second sending unit sends the process definition information and the process object data to the other one of the at least one second device to execute the next process,
the process execution control unit of the at least one second device which is the self-device determines whether the next process in the second process definition information is to be executed at the self-device, and
when the process execution control unit determines that the next process is to be executed at the self-device, the process execution unit executes the monitoring process as the next process.

5. The process executing system according to claim 4, wherein
the at least one second device which is the self-device executes the monitoring process, and receives, from the other one of the at least one second device, the process definition information in which the next process is updated and the process object data,
the process execution control unit of the at least one second device which is the self-device determines whether the next process is to be executed at the self-device, and when the next process is determined to be executed at the self-device, the process execution unit executes the next process on the process object data, and
when the next process is determined not to be executed at the self-device, the second sending unit sends the process definition information and the process object data to the other one of the at least one second device other than the self-device.

6. The process executing system according to claim 1, wherein
user information of a user operating the first device is described in the process definition information,
the at least one second device includes an authentication unit configured to determine whether user authentication is established, based on whether user information read from a user information storage unit storing user information matches the user information described in the process definition information,
when the user authentication is established, the process execution unit executes the next process on the process object data, and
the definition information updating unit updates the process definition information, and the process execution control unit updates the user information in the process definition information to user information that is used for the user authentication by the authentication unit of the at least one second device to execute the next process.

7. The process executing system according to claim 6, wherein
the at least one second device includes per-device user information in which the user information that is used for the user authentication by the authentication unit is registered in association with each of the at least one second device, and
the process execution control unit updates the user information in the process definition information, according to the user information associated with the at least one second device to execute the next process in the per-device user information.

8. A process executing method performed by a process executing system including
a first device configured to receive a plurality of processes and a setting of an execution order of the plurality of processes, and
at least one second device configured to execute the plurality of processes, wherein
the first device and the at least one second device are connected via a network, the process executing method comprising:
sending, from the first device to the at least one second device, process definition information defining process contents of each of the plurality of processes and a next process to be executed subsequently in the plurality of processes, and process object data or instruction information of the process object data;
receiving, by the at least one second device, the process definition information and the process object data or the instruction information of the process object data;
analyzing, by the at least one second device, the process definition information and determining, by the at least one second device, whether the next process is to be executed at a self-device, which is the at least one second device performing the determining;
executing, by the at least one second device, the next process on the process object data when the next process is determined to be executed at the self-device;
updating, by the at least one second device, the process definition information by changing a definition of one of the plurality of processes, which is defined to be processed after the next process according to the execution order, to be a new next process; and
sending, by the at least one second device, the process definition information and the process object data to an other one of the at least one second device other than the self-device.

9. The process executing method according to claim 8, wherein in the process definition information,
identification information of the at least one second device to execute one of the plurality of processes, is associated with each of the plurality of processes, and
the determining includes determining whether the next process is to be executed at the self-device, based on whether the identification information of the at least one second device to execute the next process matches the identification information of the self-device, and whether the next process matches one of the plurality of processes with which the identification of the self-device is associated.

10. The process executing method according to claim 8, wherein
the determining includes determining whether the next process is to be executed at the self-device again, after the next process is executed on the process object data and the process definition information is updated, and
when the next process is determined to be executed at the self-device, the next process is executed on the process object data, and
when the next process is determined not to be executed at the self-device, the process definition information and the process object data are sent to the other one of the at least one second device other than the self-device.

11. The process executing method according to claim 9, wherein
when the other one of the at least one second device to execute the next process is determined to be outside a firewall, second process definition information is created, which defines, as the next process, a monitoring process of monitoring execution of the next process performed by the other one of the at least one second device,
the sending includes sending the process definition information and the process object data to the other one of the at least one second device to execute the next process,
the determining includes determining, by the at least one second device which is the self-device, whether the next process in the second process definition information is to be executed at the self-device, and
when the next process is determined to be executed at the self-device, the monitoring process is executed as the next process.

12. The process executing method according to claim 11, wherein
the executing includes executing, by the at least one second device which is the self-device, the monitoring process, and receiving, by the at least one second device which is the self-device from the other one of the at least one second device, the process definition information in which the next process is updated and the process object data,
the determining includes determining, by the at least one second device which is the self-device, whether the next process is to be executed at the self-device, and when the next process is determined to be executed at the self-device, the next process is executed on the process object data, and
when the next process is determined not to be executed at the self-device, the process definition information and the process object data are sent to the other one of the at least one second device other than the self-device.

13. The process executing method according to claim 8, further comprising:
determining, by the at least one second device, whether user authentication is established, based on whether user information read from a user information storage unit storing user information matches user information of a user operating the first device described in the process definition information, wherein
when the user authentication is established, the next process is executed on the process object data, and
the process definition information is updated, and the user information in the process definition information is updated to user information that is used for the user authentication by the at least one second device to execute the next process.

14. The process executing method according to claim 13, wherein
the at least one second device includes per-device user information in which the user information that is used for the user authentication is registered in association with each of the at least one second device, and
the user information in the process definition information is updated, according to the user information associated with the at least one second device to execute the next process in the per-device user information.

15. An information processing device comprising:
a communicating unit configured to communicate, via a network, with a first device that receives a plurality of processes and a setting of an execution order of the plurality of processes;
a receiving unit configured to receive process definition information defining process contents of each of the plurality of processes and a next process to be executed subsequently in the plurality of processes, and process object data or instruction information of the process object data;
a process execution control unit configured to analyze the process definition information and determine whether the next process is to be executed at a self-device, which is the information processing device in which the process execution control unit is included;
a process execution unit configured to execute the next process on the process object data when the process execution control unit determines that the next process is to be executed at the self-device;
a definition information updating unit configured to update the process definition information by changing a definition of one of the plurality of processes, which is defined to be processed after the next process according to the execution order, to be a new next process; and
a sending unit configured to send the process definition information and the process object data to an other information processing device other than the self-device.

16. The information processing device according to claim 15, wherein
in the process definition information, identification information of the information processing device to execute one of the plurality of processes, is associated with each of the plurality of processes, and
the process execution control unit determines whether the next process is to be executed at the self-device, based on whether the identification information of the information processing device to execute the next process matches the identification information of the self-device, and whether the next process matches one of the plurality of processes with which the identification of the self-device is associated.

17. The information processing device according to claim 15, wherein
the process execution control unit determines whether the next process is to be executed at the self-device again, after the process execution unit executes the next process on the process object data and the definition information updating unit updates the process definition information, and
when the next process is determined to be executed at the self-device, the process execution unit executes the next process on the process object data, and
when the next process is determined not to be executed at the self-device, the sending unit sends the process definition information and the process object data to the other information processing device other than the self-device.

18. The information processing device according to claim 16, wherein
when the process execution control unit determines that the other information processing device to execute the next process is outside a firewall, the process execution control unit creates second process definition information defining, as the next process, a monitoring process of monitoring execution of the next process performed by the other information processing device,
the sending unit sends the process definition information and the process object data to the other information processing device to execute the next process,
the process execution control unit of the information processing device which is the self-device determines whether the next process in the second process definition information is to be executed at the self-device, and
when the process execution control unit determines that the next process is to be executed at the self-device, the process execution unit executes the monitoring process as the next process.

19. The information processing device according to claim 18, wherein
the information processing device which is the self-device executes the monitoring process, and receives, from the other information processing device, the process definition information in which the next process is updated and the process object data,
the process execution control unit of the information processing device which is the self-device determines whether the next process is to be executed at the self-device, and when the next process is determined to be executed at the self-device, the process execution unit executes the next process on the process object data, and
when the next process is determined not to be executed at the self-device, the sending unit sends the process definition information and the process object data to the other information processing device other than the self-device.

20. The information processing device according to claim 15, wherein
user information of a user operating the first device is described in the process definition information,
the information processing device includes an authentication unit configured to determine whether user authentication is established, based on whether user information read from a user information storage unit storing user information matches the user information described in the process definition information,
when the user authentication is established, the process execution unit executes the next process on the process object data, and
the definition information updating unit updates the process definition information, and the process execution control unit updates the user information in the process definition information to user information that is used for the user authentication by the authentication unit of the information processing device to execute the next process.
